(19) United States
(12) Patent Application Publication
(10) Pub. No.: US 2025/0042448 A1
(43) Pub. Date: Feb. 6, 2025

(54) PASSENGER TRANSPORT VEHICLE HAVING AN AIR-CONDITIONING SYSTEM

(71) Applicant: Siemens Mobility GmbH, München (DE)

(72) Inventors: Stefan Zebunke, Zapfendorf (DE); Martin Halfmann, Köln (DE); Michael Schmäcke, Stolberg (DE); Martin Ahlborn, Nettetal (DE)

(21) Appl. No.: 18/722,403

(22) PCT Filed: Dec. 16, 2022
(86) PCT No.: PCT/EP2022/086370

§ 371 Date: Jun. 20, 2024

(30) Foreign Application Priority Data
Dec. 20, 2021 (DE) 10 2021 214 657.0

(51) Int. Cl. B61D 27/00; B61D 25/00

(52) U.S. Cl. CPC B61D 27/0018; B61D 25/00

(57) ABSTRACT

A passenger transport vehicle having an air-conditioning system is controlled by an air-conditioning system controller connected to at least one temperature sensor for a vehicle passenger compartment, and includes an air-conditioning device and a plurality of air ducts supplying conditioned inlet air provided by the air-conditioning device to the passenger compartment and removing air from the passenger compartment. The air-conditioning system controller controls the air-conditioning device to regulate the temperature in the passenger compartment, such that the air-conditioning device delivers inlet air temperature-adjusted to set a predefined target temperature in the passenger compartment. A plurality of window panes that can be darkened have a degree of darkening which can be adjusted electrically. The air-conditioning system controller controls the degree of darkening of the window panes to set the predefined target temperature in the passenger compartment.

The invention relates to a passenger transport vehicle according to the preamble of claim 1, and to a method for controlling an air-conditioning system of such a vehicle.

The invention discloses a passenger transport vehicle, having an air-conditioning system that is controlled by means of an air-conditioning system controller connected to at least one temperature sensor for a passenger compartment of the vehicle and that comprises an air-conditioning device and a plurality of air ducts for supplying the passenger compartment with conditioned inlet air provided by the air-conditioning device and for removing air from the passenger compartment, wherein the air-conditioning system controller, for the purpose of regulating a temperature of the passenger compartment, controls the air-conditioning device in such a way that the latter delivers temperature-adjusted inlet air for the purpose of setting a predetermined setpoint temperature of the passenger compartment.

The adjusting of a setpoint temperature for the passenger compartment of a passenger transport vehicle, in particular a rail vehicle, is thus based on a corresponding control of the air-conditioning system. The operation of the latter is set in such a way that, for example if the temperature falls below a wanted setpoint temperature, the temperature of the inlet air delivered by the air-conditioning device is increased, for example by the activation of a heating register. If the setpoint temperature is exceeded, the operation of the air-conditioning device is adapted in such a way that the inlet air conveyed into the passenger compartment is of such a low temperature, e.g. as a result of being cooled, that the wanted setpoint temperature is attained.

Overall, the regulation of the temperature for the passenger compartment is based solely on the influencing of the operation of the air-conditioning device. Especially for passenger transport vehicles that are operated without overhead lines, it is desirable to minimize energy consumption. This also applies in particular to the air conditioning of the passenger compartment.

Air-conditioning systems and methods for controlling them that are already known from the field of (electric) passenger cars, such as those known, for example, from the document US 2021/0061053 AI, are not comparable to passenger transport vehicles, such as rail vehicles, due to the substantially more complex structure of the air-conditioning system these vehicles, and the size of the vehicles.

Proceeding from this, the invention is based on the object of further developing a vehicle of the type mentioned at the beginning in such a way that the air-conditioning system used therein consumes less energy, and of specifying a method for controlling the air-conditioning system of such a vehicle.

This object is achieved by a vehicle having the features of claim 1. According to this, the vehicle of the type mentioned at the beginning is characterized in that the passenger transport vehicle is equipped with a plurality of window panes that can be darkened, the degree of darkening of which can be set electrically, and the air-conditioning system controller is designed in such a way that it controls a degree of darkening of the window panes for the purpose of setting the predetermined setpoint temperature of the passenger compartment. This may involve the darkening of both visible light and non-visible solar radiation. In this case, shading-over of the entire area of solar radiation is more effective with regard to the reduction of the heat input into the vehicle.

The passenger transport vehicle is preferably a rail vehicle for transporting passengers.

It is thus an essential aspect of the invention that the passenger transport vehicle is equipped with vehicle windows that can be darkened, and the control of the degree of darkening for these vehicle windows capable of being darkened is incorporated into an air-conditioning system controller. This means, for example, that in the case of very strong solar radiation, which causes the temperature in passenger compartment to be increased, the degree of darkening of the vehicle windows is selectively increased. As a result, the amount of cooling by the air conditioning device that is required to cool down the air in the passenger compartment is reduced. The basis for this is that the introduction of heat into the air in the passenger compartment as a result of solar radiation is reduced in an effective manner by appropriate setting of the degree of darkening of the dimmable window panes.

Window panes that can be darkened/dimmed are known in the prior art and are already used, for example, in the field of building technology. Common terms for this are ‘smart glass’ or ‘intelligent glass’. Various technologies are used here, such as the application of films or coatings to conventional window panes. The setting of a degree of darkening of such film-covered or coated window panes is effected electrically by the application of a voltage to electrochromic glass.

The air-conditioning system controller is designed in such a way that, for the purpose of setting the setpoint temperature of the passenger compartment, it controls the degree of darkening for the window panes in priority. In particular, in the case of strong solar radiation, which causes heat to be introduced into the air in the passenger compartment, the degree of darkening is therefore first increased by electrical activation of the window panels in order to set the wanted setpoint temperature. If this is not sufficient to attain the setpoint temperature, the air conditioning device is then additionally operated in such a way that the inlet air temperature set there is used to attain the setpoint temperature for the passenger compartment.

In particular, it is also possible for the degree of darkening of the window panes not to be set to the maximum, but rather in such a way that an optimum is achieved, such that the window panes do not fall below a minimum transmission of visible light so as to allow observation of the surroundings, and for a reasonable energy consumption by the air-conditioning system to be accepted.

For the purpose of sensing an outside temperature that, in particular, indicates strong solar radiation, the air-conditioning system controller may be connected to an outside-temperature sensor and/or at least one environment-sensor arrangement. Measurement values supplied by the outside-temperature sensor are then integrated into the control of the degree of darkening of the window panes and also into the temperature of the inlet air supplied by the air-conditioning device.

The plurality of window panes may be realized such that they can be electrically darkened only in what, in relation to the vehicle, is their upper region. Darkening only an upper half or an upper third of the window panes, for example, already has a substantial effect on the reduction of the input of heat into the passenger compartment.

A remaining region of the window panes may then be designed, for example, so as to be particularly transmissive of mobile telephony waves.

It is additionally possible for the air-conditioning system controller to be connected to a door controller of the vehicle, and to be designed in such a way that, for the purpose of setting the predetermined setpoint temperature of the passenger compartment, it takes into consideration opening times of vehicle doors and an associated exchange of air and heat between the passenger compartment and an environment of the vehicle.

In this way, the general air-conditioning system controller also takes into account the extent to which the properties of the air in the passenger compartment are influenced by opening the vehicle doors.

It may also be provided that the air-conditioning system controller is a central controller configured to control the degree of darkening of all window panes of the vehicle.

This is a central controller for darkening the windows of the entire vehicle.

This allows the entire vehicle, i.e. the entire passenger compartment, to be darkened in certain operating situations. Instead of individual, and therefore arbitrary, operation (window blind, darkening operating system on each window), a central control is realized.

In a development of the vehicle, it may also be provided that the air-conditioning system controller is connected to at least two environment-sensor arrangements, which are configured to determine the light intensity on at least two longitudinal sides of the vehicle, and the air-conditioning system controller is configured to control the degree of darkening of all window panes on a first longitudinal side of the vehicle independently of the window panes on a second longitudinal side of the vehicle, in dependence on the respectively detected light intensity.

The air-conditioning system controller is designed in such a way that the window panes on the sunny side can be darkened, while the windows on the shady side are not darkened. This may also be effected automatically when the direction of travel changes.

This allows one longitudinal side of the vehicle that is exposed to solar radiation to be darkened, whereas the other longitudinal side of the vehicle is not darkened.

In the design of the vehicle, it may also be provided that the plurality of window panes that can be darkened comprise at least one side window of the passenger compartment and/or comprise at least one door window of the passenger compartment.

This allows the windows on one side of the vehicle to be substantially completely darkened, and both an entry area and the rest of the passenger compartment can be darkened.

Furthermore, in an advantageous development of the vehicle, it may be provided that the air-conditioning system controller is connected to a position determination system, and the degree of darkening of the window panes of the vehicle can be controlled on the basis of an ascertained position.

The position determination system may be, for example, a satellite-based position determination system.

This makes it possible for a predetermined degree of dimming to be set in dependence on the position of the vehicle along a route.

The degree of dimming of the window panes of the vehicle may be controlled in this way, for example, during travel through a tunnel or upon entry to a railway station.

In the design of the vehicle, it may also be provided that the air-conditioning system controller is configured to control the degree of darkening of the window panes of the vehicle in such a way that they can be darkened before and/or after passenger operation.

For example, a dimming function may be implemented in the air-conditioning system controller when the vehicle is parked, or a dimming function may be implemented when the vehicle is upgraded, for example to cool down the interior before passenger operation.

In respect of the method, the above object is achieved by a method according to the features of claim 12, while preferred embodiments of the method are given by claims 13 to 21. Principal features and advantages of the method have already been explained above with reference to the description of the passenger transport vehicle having a special air-conditioning system controller.

An exemplary embodiment of the invention is explained in yet greater detail below with reference to the drawings, in which:

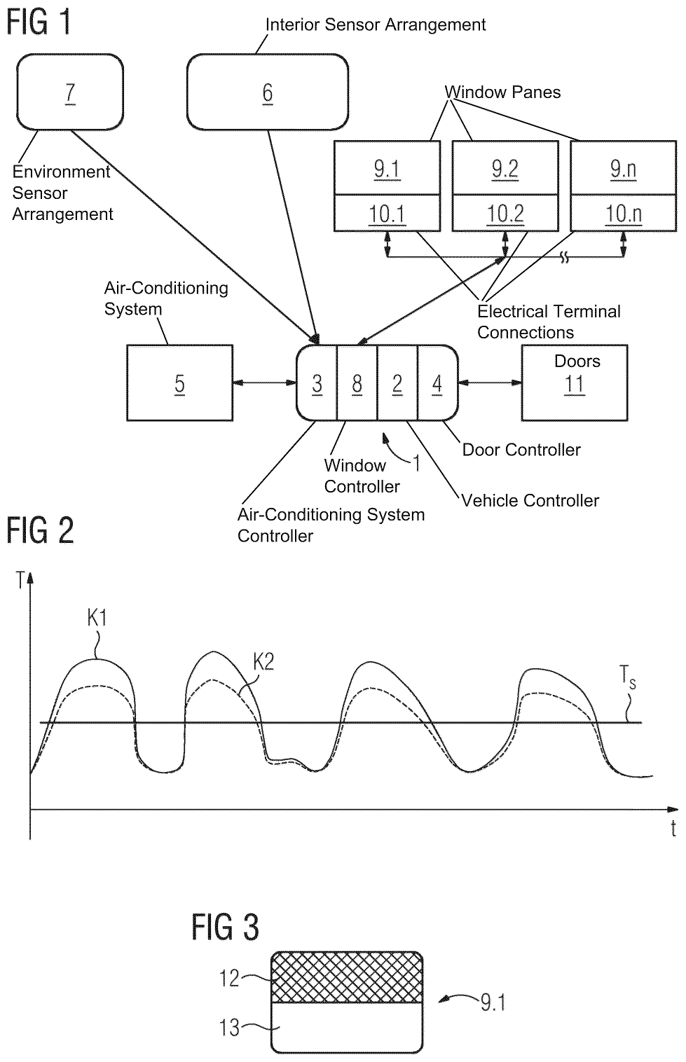

FIG. 1 shows a function diagram to explain an air-conditioning system controller in the case of a passenger transport vehicle,

FIG. 2 shows a qualitative, graphical representation of temperature characteristics over time in the passenger compartment, and

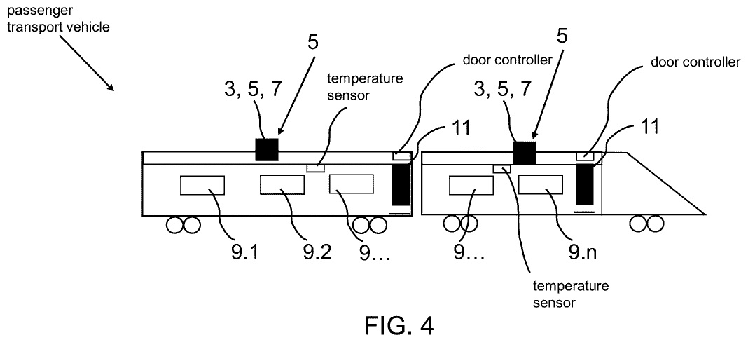

FIG. 3 shows a schematic side view of a window pane that can be darkened.

As can be seen from the function diagram in FIG. 1, provided in a carriage of a multi-part rail vehicle there is a higher-level control unit 1, which controls a multiplicity of functions of the vehicle. The control unit 1 comprises a vehicle controller 2, an air-conditioning system controller 3 and a door controller 4.

The air-conditioning system controller 3 controls an air-conditioning system 5, which is provided to convey conditioned inlet air into a passenger compartment of the vehicle by means of an air-conditioning device, which is designed to both cool and heat fresh air drawn in from the environment of the vehicle. For the purpose of suitably conditioning the inlet air so that the air in the passenger compartment complies with predefined set values for temperature, carbon dioxide content, air humidity, . . . . , the air conditioning system 1 has a signal connection to an interior sensor arrangement 6 The interior sensor arrangement 6 also comprises a sensor system for sensing the degree of passenger occupancy in the passenger compartment. In addition, the air-conditioning system 5 receives from an environment-sensor arrangement 7 current measurement values for solar radiation received by the vehicle, an outside temperature of the environment, etc.

The control unit 1 additionally comprises a window controller 8 for setting a degree of darkening for a plurality of window panes 9.1, 9.2, . . . , 9.n that can be darkened. Each of the window panes 9.1, 9.2, . . . , 9.n provided is equipped with an associated electrical terminal connection 10.1, 10.2, . . . , 10.n, via which a voltage supplied by the window controller 8, for setting a wanted degree of darkening of the window panes 9.1, 9.2, . . . , . . . , 9.n, is applied to a coating or film of the window panes 9.1, 9.2, . . . 9.n. The control unit 1 additionally controls, via the door control unit 4, opening and closing operations for the doors 11 provided on the vehicle.

A setpoint Tₛ for the temperature in the passenger compartment is stored in the air-conditioning system controller 3, and deviations between this setpoint and temperature values for the passenger compartment currently measured by means of the sensor arrangement 6 are determined. If a current actual temperature exceeds the setpoint value Tₛ for the temperature in the passenger compartment, the degree of darkening of the window panes 9.1, 9.2, . . . , 9.n is first increased in priority, or the maximum value thereof is set, as far as this is permitted by a current setting of the degree of darkening of the window panes. If an increase in the degree of darkening of window panes 9.1, 9.2, . . . , 9.n alone does not yet allow the temperature in the passenger compartment to attain the setpoint value Tₛ, the air-conditioning system 5 is additionally operated in such a way that a provided air-conditioning device produces inlet air for the passenger compartment, the temperature of which inlet air allows the setpoint temperature Tₛ for the passenger compartment to be attained within a suitable period of time.

The air-conditioning system controller 3 additionally takes into consideration the opening times for the doors 11, as open doors allow both a thermal interaction between the air in the passenger compartment and the ambient air as well as the entry of heat into the passenger compartment due to solar radiation.

FIG. 2 shows the variation of temperature over time in the passenger compartment of the vehicle, with a first curve KI illustrating the temperature characteristic without any influencing the degree of darkening of the window panes 9.1, 9.2, . . . , 9.n. A second curve K2 in FIG. 2 shows the temperature characteristic on the same time scale with maximally darkened window panes 9.1, 9.2, . . . , 9.n. The time curves each cover several days, with a pronounced temperature maximum being identifiable for each day. Also shown in FIG. 2 is the setpoint temperature Tₛ for the passenger compartment. It can be seen that the temperature maxima of the curve KI (no darkening of the window panes) are significantly more pronounced than in curve K2 (maximum darkening). As a result of this, the amount of cooling that has to be provided by the air-conditioning system 5 is less than when the window panes are set to darken. This in turn reduces the energy consumption of the air-conditioning system, as less cooled inlet air has to be produced in order to attain the setpoint temperature for the passenger compartment.

FIG. 3 illustrates that the window panes 9.1, 9.2, . . . , 9.n do not have to be capable of being darkened over their entire surface area. Rather, the window panel 9.1 shown here as an example in FIG. 3 is such that it can be darkened only in its upper half 12, while a lower region 13 of the window panes 9.1 may be optimized, for example, for the transmission of mobile telephony waves.

1-21. (canceled)

22. A passenger transport vehicle or rail vehicle, comprising:
a passenger compartment;
an air-conditioning system;
an air-conditioning system controller controlling said air-conditioning system;
at least one temperature sensor for said passenger compartment, said at least one temperature sensor connected to said air-conditioning system controller;
an air-conditioning device;
a plurality of air ducts for supplying said passenger compartment with conditioned inlet air provided by said air-conditioning device and for removing air from said passenger compartment;
said air-conditioning system controller controlling said air-conditioning device for regulating a temperature of said passenger compartment by causing said air-conditioning device to deliver temperature-adjusted inlet air for setting a predetermined setpoint temperature of said passenger compartment; and
a plurality of window panes configured to be darkened and having an electrically settable degree of darkening;
said air-conditioning system controller configured to control said degree of darkening of said plurality of window panes for setting the predetermined setpoint temperature of said passenger compartment.

23. The vehicle according to claim 22, wherein said air-conditioning system controller is configured to control said degree of darkening for said plurality of window panes in priority, for setting the predetermined setpoint temperature of said passenger compartment.

24. The vehicle according to claim 22, which further comprises at least one of an outside-temperature sensor or at least one environment-sensor arrangement connected to said air-conditioning system controller.

25. The vehicle according to claim 22, wherein said plurality of window panes have an upper region relative to the vehicle, and said plurality of window panes are configured to be electrically darkened only in said upper region.

26. The vehicle according to claim 25, wherein said plurality of window panes have a remaining region being transmissive to mobile telephony waves.

27. The vehicle according to claim 22, which further comprises:
vehicle doors;
a door controller;
said air-conditioning system controller being connected to said door controller; and
said air-conditioning system controller being configured to take into consideration opening times of said vehicle doors and an associated exchange of air and heat between said passenger compartment and an environment of the vehicle, for setting the predetermined setpoint temperature of said passenger compartment.

28. The vehicle according to claim 22, wherein said air-conditioning system controller is a central controller configured to control said degree of darkening of all of said plurality of window panes.

29. The vehicle according to claim 22, which further comprises:
at least first and second longitudinal sides of the vehicle each having some of said plurality of window panes;
at least two environment-sensor arrangements configured to determine light intensity on said at least first and second longitudinal sides;
said air-conditioning system controller connected to said at least two environment-sensor arrangements; and
said air-conditioning system controller configured to control said degree of darkening of said window panes on said first longitudinal side independently of said window panes on said second longitudinal side, in dependence on respectively detected light intensities.

30. The vehicle according to claim 22, wherein:
said passenger compartment has at least one of at least one side window or at least one door window; and
said plurality of window panes configured to be darkened include at least one of said at least one side window or said at least one door window.

31. The vehicle according to claim 22, which further comprises a position determination system for ascertaining a vehicle position, said air-conditioning system controller being connected to said position determination system for controlling said degree of darkening of said plurality of window panes based on said ascertained position.

32. The vehicle according to claim 22, wherein said air-conditioning system controller is configured to control said degree of darkening of said plurality of window panes to permit said plurality of window panes to be darkened at least one of before or after passenger use.

33. A method for controlling an air-conditioning system of a passenger transport vehicle or rail vehicle, the method comprising:
providing an air-conditioning device, an air-conditioning system controller connected to at least one temperature sensor for a passenger compartment of the vehicle, and a plurality of air ducts for supplying the passenger compartment with conditioned inlet air provided by the air-conditioning device and for removing air from the passenger compartment;
using the air-conditioning system controller to control the air-conditioning device for regulating a temperature of the passenger compartment and for causing the air-conditioning device to deliver temperature-adjusted inlet air for setting a predetermined setpoint temperature of the passenger compartment;
providing a plurality of window panes configured to be darkened and having an electrically settable degree of darkening; and
using the air-conditioning system controller to control the degree of darkening of the plurality of window panes for setting the predetermined setpoint temperature of the passenger compartment.

34. The method according to claim 33, which further comprises using the air-conditioning system controller to control the degree of darkening of the plurality of window panes in priority, for setting the setpoint temperature of the passenger compartment.

35. The method according to claim 33, which further comprises connecting the air-conditioning system controller to at least one of an outside-temperature sensor or at least one environment-sensor arrangement.

36. The method according to claim 33, which further comprises setting the degree of darkening of the plurality of window panes only at an upper region, relative to the vehicle, of the plurality of window panes.

37. The method according to claim 33, which further comprises connecting the air-conditioning system controller to a door controller of the vehicle, and taking into consideration opening times of vehicle doors and an associated exchange of air and heat between the passenger compartment and an environment of the vehicle, for setting the predetermined setpoint temperature of the passenger compartment.

38. The method according to claim 33, which further comprises providing the air-conditioning system controller as a central controller controlling the degree of darkening of all of the plurality of window panes.

39. The method according to claim 33, which further comprises:
connecting the air-conditioning system controller to at least two environment-sensor arrangements determining light intensity on at least a first and a second longitudinal side of the vehicle each having some of the plurality of window panes; and
using the air-conditioning system controller to control the degree of darkening of the window panes on the first longitudinal side of the vehicle independently of the window panes on the second longitudinal side of the vehicle, in dependence on respectively detected light intensities.

40. The method according to claim 33, which further comprises using the air-conditioning system controller to control at least one of at least one side window of the passenger compartment or at least one door window of the passenger compartment of the plurality of window panes configured to be darkened.

41. The method according to claim 33, which further comprises connecting the air-conditioning system controller to a position determination system, and controlling the degree of darkening of the plurality of window panes based on an ascertained vehicle position.

42. The method according to claim 33, which further comprises using the air-conditioning system controller to control the degree of darkening of the plurality of window panes at least one of before or after passenger use.
